(19) United States
(12) Patent Application Publication
(10) Pub. No.: US 2005/0045549 A1
(43) Pub. Date: Mar. 3, 2005

(54) Filter assembly for sprayers

(76) Inventor: George Lutich, Clearwater, FL (US)

Correspondence Address: MAYER, BROWN, ROWE & MAW LLP, 190 SOUTH LASALLE ST, CHICAGO, IL, 60603-3441, US

(21) Appl. No.: 10/618,470

(22) Filed: Jul. 11, 2003

Related U.S. Application Data
(63) Continuation-in-part of application No. 09/781,865, filed on Feb. 12, 2001.
(63) Continuation-in-part of application No. 09/766,031, filed on Jan. 19, 2001, now abandoned.
(63) Continuation-in-part of application No. 09/736,637, filed on Dec. 14, 2000, now Pat. No. 6,599,428.
Application No. 09/736,637 is a continuation-in-part of application No. 09/431,942, filed on Oct. 1, 1999, now abandoned.
(60) Provisional application No. 60/249,033, filed on Nov. 15, 2000.
(60) Provisional application No. 60/395,510, filed on Jul. 12, 2002.

(51) Int. Cl. B01D 27/00

(52) U.S. Cl. 210/295

(57) ABSTRACT

An improved filter device for the removal of contaminants from water and method of using same. Disclosed is a filter assembly for a spray attachment and/or a detachable faucet wand that is easily replaced and either concealed or partially concealed.

### RELATED APPLICATIONS

This application (1) is a continuation-in-part of U.S. application Ser. No. 09/781,865, filed on Feb. 12, 2001, which claims priority to U.S. Pat. Provisional Application Ser. No. 60/249,033, filed Dec. 7, 2000; (2) is a continuation-in-part of U.S. patent application Ser. No. 09/766,031, filed Jan. 19, 2001; (3) is a continuation-in-part of U.S. patent application Ser. No. 09/736,637, filed Dec. 14, 2000, which is a continuation-in-part of U.S. patent application Ser. No. 09/431,942 filed Oct. 1, 1999; and (4) claims priority to U.S. Provisional Application Ser. No. 60/395,510, filed Jul. 12, 2002, the disclosures of which are incorporated by reference herein to the extent permitted by law.

### FIELD OF THE INVENTION

The present invention relates to fluid treatment. In particular, the present invention relates to water filtration devices for sink spray attachments and detachable faucet wands.

### BACKGROUND OF THE INVENTION

Tap water contains many contaminants. If not removed from the water, these contaminants may present health risks, may damage plumbing and personal property, and may adversely affect the taste of water. The principal contaminants naturally occurring in water are iron, sulfur, manganese, lead, and cryptosporidium cysts. Many man-made contaminants are also now found in tap water. These man-made contaminants may be introduced into the water supply as part of or as by-products of herbicides, pesticides, fertilizers and the like placed on and into the ground. These contaminants are believed to be carcinogenic and may present serious long term health risks to users of this contaminated water.

Traditionally, water filters have been placed under the main faucet spout, thereby filtering the water after it has traveled through the main faucet. Water filters of the prior art have been attached to sink faucets by various mechanisms. Typically, filters are mounted onto the threads of a faucet diverter section or have hoses attached thereto. The filter cartridge protrudes sideways or upwards from the diverter section into the upper work area of the sink or is placed behind the faucet. The placement of the filter in these positions is cumbersome for a user cleaning dishes or performing routine hygienic functions. Further, the placement of the filter outward and upward from the faucet is in plain view and unsightly to the user. Providing filtered water outside of the sink area is also difficult to accomplish with filters that are placed on the main faucet. Therefore, a concealed or partially concealed water filter for a spray attachment is desirable to provide filtered water outside of the sink area.

Several water filters of the prior art have been placed in a faucet spray wand assembly. However, the filters of the prior art require cumbersome dismantling of the spray wand to replace the used cartridge.

### SUMMARY OF THE INVENTION

The foregoing problems are solved and a technical advance is achieved by the present invention. Disclosed is a filter assembly for a spray attachment and/or a detachable faucet wand that is easily replaceable.

### BRIEF DESCRIPTION OF THE DRAWINGS

FIG. 1 is an isometric view with a partial cross-section of a standard spray attachment of the prior art.

FIG. 2 is an isometric view with a partial cross-section of a standard spray housing of the prior art.

FIG. 3A is a cross-sectional view of an embodiment of the filter assembly of the present invention.

FIG. 3B is a cross-sectional view of the embodiment shown in FIG. 3A showing the direction of water flow.

FIG. 4 is a bottom plan view of an end cap for the filter assembly shown in FIG. 3A showing radial ribs that direct the water flow.

FIG. 5 is a cross-sectional view of another embodiment of the filter assembly of the present invention.

FIG. 6 is an isometric view with a partial cross-section of an embodiment of a spray head of the present invention.

FIG. 7 is a cross-sectional view of another embodiment of the filter assembly of the present invention.

FIG. 8 is a partial isometric view of a two handle faucet assembly with a spray attachment utilizing a filter assembly of the present invention.

FIG. 9A is a partial isometric view of a single handle faucet assembly with a spray attachment utilizing another embodiment of the filter assembly of the present invention.

FIG. 9B an enlarged isometric view of an adapter tee of the present invention.

FIG. 10 is a partial isometric view of a single handle faucet assembly without a spray attachment utilizing another embodiment of the filter assembly of the present invention.

FIG. 11 is an isometric view with a partial cross-section of a spray attachment and filter assembly of the present invention.

FIG. 12A is a cross-sectional view of a spray attachment and filter assembly of the present invention.

FIG. 12B is a cross-sectional view of a typical installation of the spray attachment of FIG. 12A.

FIG. 12C is an enlarged cross-sectional view of an embodiment of a fitting utilized in the present invention.

FIG. 13A is a bottom view of one embodiment of a spray attachment of the present invention

FIG. 13B is a side view of the spray attachment of FIG. 13A.

FIG. 14 is a top perspective exploded view of one embodiment of a spray attachment of the present invention.

FIG. 15 depicts a cross-section of the spray attachment of FIG. 14.

FIG. 16 is a top perspective exploded view of a portion of a selector valve of FIG. 14.

FIG. 17A depicts a cross-section of an alternate embodiment of a selector valve of the present invention in the off position.

FIG. 17B depicts a cross-section of an alternate embodiment of a selector valve of the present invention in the stream position.

FIG. 17C depicts a cross-section of an alternate embodiment of a selector valve of the present invention in the spray position.

### DETAILED DESCRIPTION

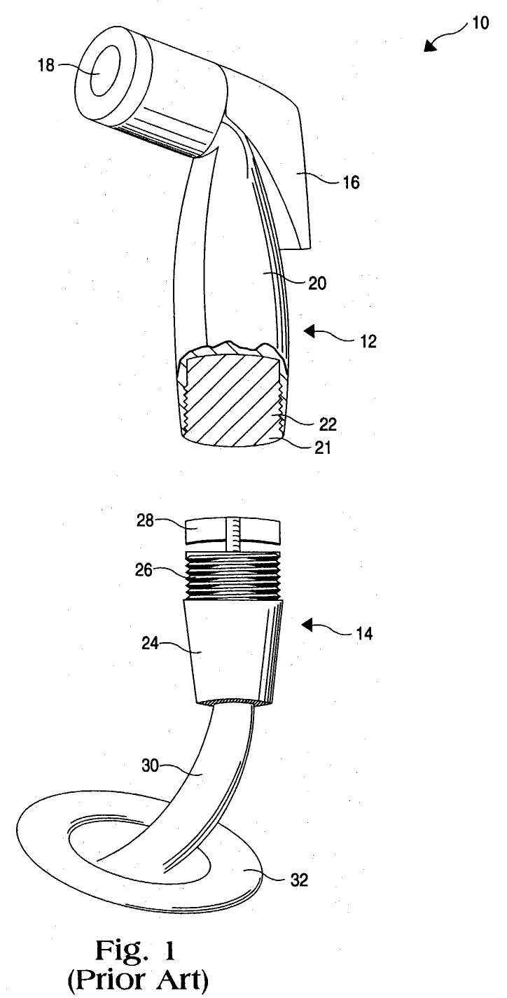

FIG. 1 depicts a spray attachment 10 as is generally known in the art. The spray attachment 10 is standard for most kitchen sinks. The spray attachment 10 comprises a spray head 12 and a spray hose assembly 14. A spray handle 16 extending from a spray body 20 of the spray head 12 may control the release of water out of a nozzle 18. Alternatively, the spray head 12 may have other mechanisms as are generally known in the art that control the release of water out of the nozzle 18. The spray body 20 also houses other elements necessary for holding and dispensing water from the spray head 12 as are well known in the art including but not limited to valves, channels, seals, and flow restrictors. The spray body 20 of the spray head 12 detachably attaches to the spray hose assembly 14. The spray body 20 comprises an opening 21 which receives a spray hose coupling 24 of the spray hose assembly 14. In one embodiment, a female end 22 of the spray body 20 receives a male end 26 of the spray hose coupling 24 of the spray hose assembly 14. The spray hose coupling 24 detachably attaches the spray head 12 to a spray hose 30 of the spray hose assembly 14 with threads or other coupling mechanisms as are generally known in the art. In one embodiment, the female end 22 having ¼ inch NSP internal threads receives the male end 26 having ¼ inch NSP external threads.

The spray hose 30 provides a water supply that is dispensed through the nozzle 18 of the spray head 12. The spray hose assembly 14 has a seal 28 that prevents water from leaking from the spray hose 30 when the male end 26 of the spray hose assembly 14 is detachably attached to the female end 22 of the spray head 12. The spray attachment 10 may remain in a resting position in a spray holder 34 affixed to a sink or may be extended out of the spray holder 34 and hand-held in an extended position for use in areas outside of the sink.

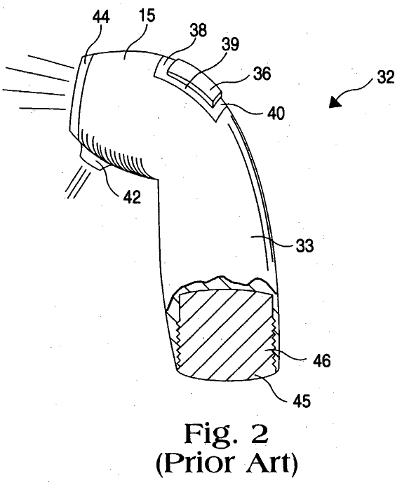

As depicted in FIG. 2, it is known that the spray head 32 may dispense water in a spray or stream pattern. A selector valve 36 on the spray head 32 has a stream position 38, an off position 39, and a spray position 40 which controls the pattern for dispensing water. FIG. 2 depicts the selector valve 36 as a switch which slides into the stream position 38 when a user pushes the selector valve up along the spray body 33, into the spray position 40 when a user pushes the valve down along the spray body 33, and into the off position 39 when the user pushes the valve into a position between the stream position 38 and the spray position 40. One skilled in the art would recognize that the stream, off, and spray positions 38, 39, and 40, respectively, may be interchanged, and further may be controlled by other selector mechanisms as are generally known in the art. When the selector valve 36 is in the stream position 38, water dispenses through a stream spout 42 on the spray body 33. When the selector valve 36 is in the spray position 40, water dispenses through a spray spout 44 of the spray body 33. The spray hose assembly 14 (FIG. 1) may detachably attach to the spray head 32 in the manner described above. In one embodiment, the water dispensed from the stream spout 42 is directed downwardly toward the sink and the water dispensed from the spray spout 44 is directed away from the sink. Therefore, typically, the spray position 40 may be used when the spray attachment 10 is in the extended position so as to direct the spray spout 44 at a desired object. The spray head 32 comprises an opening 45 which can receive a spray hose coupling 24 (FIG. 1). In one embodiment, a female end 46 of the spray body 33 receives a male end 26 of a spray hose coupling 24 (FIG. 1).

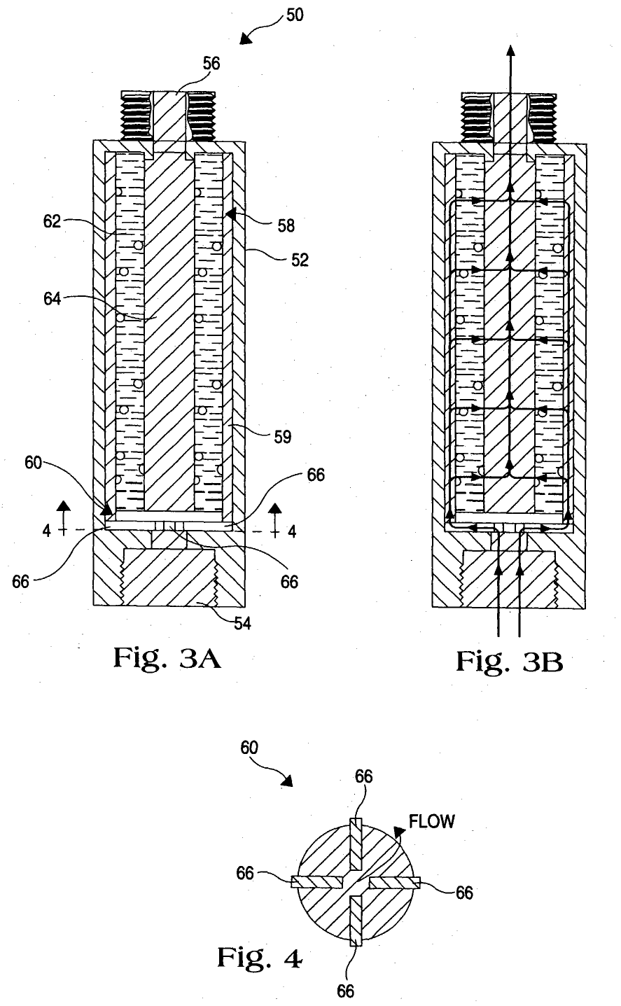

FIGS. 3A and 3B depict a filter assembly 50 for filtering water supplied to the spray attachment 10 wherein the spray attachment may include spray head 12 or, alternatively, spray head 32. The filter assembly 50 reduces the amount of particles and other contaminants in the water supply and improves the taste and odor of the water supply. The filter assembly 50 includes a housing 52 having an inlet 54 and an outlet 56 to allow water to flow through the housing 52. The housing 52 is preferably constructed or injection molded of acrylonitrile-butadiene-styrene (ABS). Those skilled in the art, however, will appreciate that any suitable temperature resistant thermoplastic material or other suitable material may be utilized for the housing 52. As shown in FIG. 3A, the inlet 54 of the filter assembly 50 mates with the spray hose coupling 24 of the spray hose assembly 14 (FIG. 1) and the outlet 56 mates with the opening 21 of the spray head 12 (FIG. 1) or the opening 45 of the spray head 32 (FIG. 2) to provide filtered water to the spray head 12 or 32. One skilled in the art would recognize that any filter assembly 50 may be employed in the present invention as long as the inlet 54 and the outlet 56 are configured to mate with both the spray hose coupling 24 and the opening 21 or 45, respectively. In one embodiment of the present invention, the inlet 54 has internal threads and the outlet 56 has external threads which correspond with the male end 26 and female end 22 or 46 threads, respectively. In one embodiment, the inlet 54, the outlet 56, the male end 26 and the female end 22 or 46 all have ¼ inch NSP threads. The configuration of the inlet 54, the outlet 56, the opening 21 or 45, and the spray hose coupling 24 may be reversed so that the inlet 54 has external threads to engage a female end on the spray hose assembly 14 and the outlet 56 has internal threads to engage a male end in the opening 21 or 45.

In one embodiment, depicted in FIG. 3A, the filter assembly 50 may further comprise a filter cartridge 58, a channel 59, and an end cap 60. As depicted in FIG. 3A and FIG. 4, radial ribs 66 on the end cap 60 fix the position of the filter cartridge 58 in the housing 52. The end cap 60 seals the filter assembly 50 at the inlet 54 to prevent flow of the filtered water back into the spray hose 30. FIG. 3B shows the direction of water flow through the filter assembly 50. The water flows around the radial ribs 66 into the channel 59. The channel 59 fluidly communicates with the inlet 54 and provides a path for the water supply to reach the filter cartridge 58. The filter cartridge 58 comprises a media 62 and an axial void 64 running down the center of the housing 52. The media 62 may include but are not limited to carbon block, copper, copper-zinc, far infrared media, KDF, and activated titanium carbon (“ATC”). Any suitable filtering media may be employed. The media 62 work especially well in sulfated waters where sulfates have been used as sequestering or flocculating agents. Other contaminants in water, like lead and other heavy metals, are removed or reduced as the contaminant is bonded to the media 62. Further, it is believed that oxidation/reduction reactions occurring within the media 62 control microbial growth. Organisms specifically controlled include fungi, algae and bacteria. Once the water supply travels through the media 62 in the cartridge 58, the water exits the filter assembly 50 through the axial void 64 and the outlet 56.

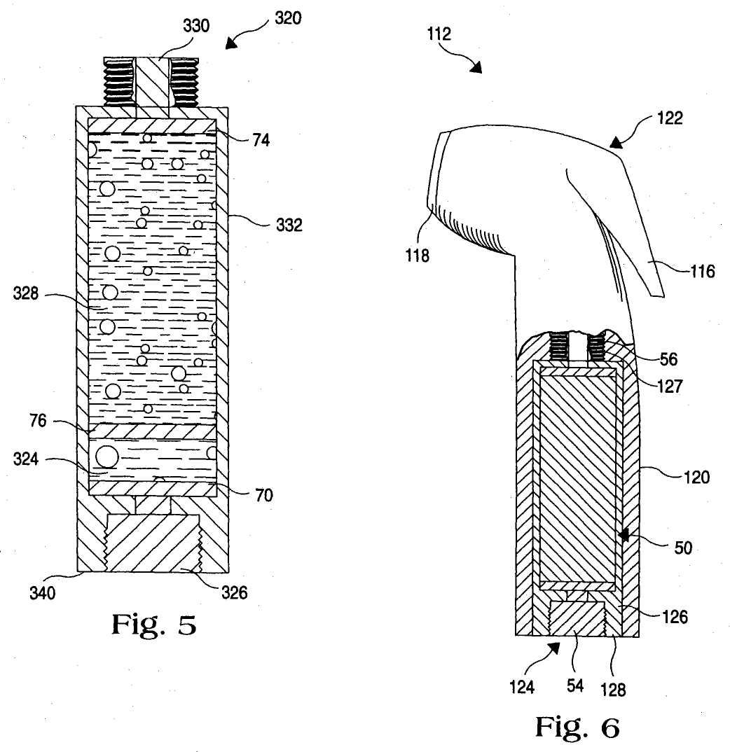

FIG. 5 depicts another embodiment of the filter assembly 320. The filter assembly 320 may include filter pads for preventing the media from traveling outside of the housing. For example, an inlet pad 70 inside the housing 332 prevents the first media 324 from traveling through the inlet 326 and an outlet pad 74 prevents the second media 328 from traveling through the outlet 330. In one embodiment, various types of filtering media may be employed for the first media 324 and the second media 328 which may be separated into separate chambers by at least one interior pad 76. The media 324 and 328 may include but are not limited to any combination of far infrared, copper, granulated activated carbon, KDF, and ATC. The skilled artisan will appreciate that the interior pad 76 need not be present to accomplish the objective of the present invention. In such an embodiment, the housing 332 is sequentially filled with different types of media such that there are substantially distinct areas of the different media, yet they are in contact with each other. The inlet pad 70, the outlet pad 74, and the interior pad 76 may be constructed from any type of porous material including but not limited to stainless steel mesh or screens, Porex, plastic mesh or screens, and sintered metal.

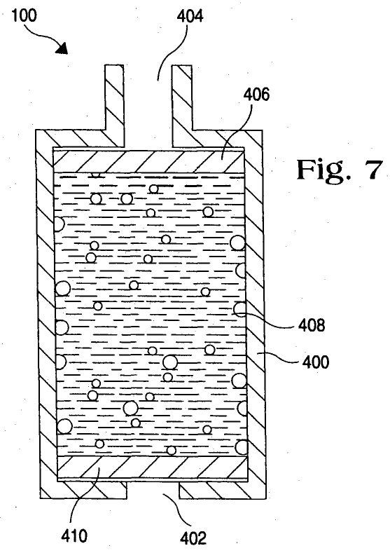

In another embodiment of the present invention depicted in FIG. 6, a filter assembly 50 may be inserted into a spray head 112. The spray head 112 comprises a spray handle 116, a nozzle 118, and a spray body 120. The spray body 120 is elongated in comparison to those generally known in the art to conceal the filter assembly 50 inside the spray head 112. The spray body 120 has a distal end 122 and a proximal end 124 and a cavity 126 extending from the proximal end 124 to at least partially the distal end 122. The distal end 122 comprises the spray handle 116 and the nozzle 118 as well as other water dispensing components (not shown) as are generally known in the art for controlling the flow of water out of the spray head 112. Water dispensing components include but are not limited to valves, channels, seals, and flow restrictors. The cavity 126 houses the filter assembly 50. The proximal end 124 of the spray body 120 has an opening 128 for receiving the filter assembly 50 into the cavity 126. In one embodiment, toward the distal end 122 of the spray body 120, the cavity 126 has a female end 127 to receive the outlet 56 of the filter assembly 50. The female end 127 has internal threads that receive the external threads of the outlet 56. When the outlet 56 engages the female end 127 of the cavity 126, the filter assembly 50 is detachably attached to the spray head 112. The spray hose assembly 14 described above may be employed to fluidly communicate with the proximal end 124 of the spray body 120 and the inlet 54 of the filter assembly 50. The spray hose coupling 24 (FIG. 1) detachably attaches to the inlet 54 as described above. Alternatively, the filter assembly 320, as shown in FIG. 5. can be inserted into spray head 112 in a manner similar to that described for spray head 32.

The filter assembly 50 or 320 may serve as the primary and only filter or may be secondary to or replaced by a second filter assembly 100. FIGS. 7-10 depict a second filter assembly 100 for filtering water supplied to a spray attachment 10 (which may or may not include a filter assembly 50 or 320), which may be concealed under a sink.

As depicted in FIG. 7, the second filter assembly 100 comprises a housing 400 having an inlet 402 and an outlet 404 to allow water to flow through the housing 400 with the outlet pad 406 impeding the filtering media 408 from traveling through the outlet 404. In one embodiment, various types of filtering media may be employed, which may be separated into separate chambers (not shown) by interior pads (not shown) in a manner similar to that shown in FIG. 5. The skilled artisan will appreciate that the interior pad need not be present to accomplish the objective of the present invention. In such an embodiment, the housing 400 is sequentially filled with different types of media such that there are substantially distinct areas of the different media, yet they are in contact with each other. In another embodiment, the inlet pad 410 impedes the movement the filtering media 408 through the inlet 402. The same materials may be used for the media 408 and the housing 400 as well as the outlet pad 406, the inlet pad 410, and the interior pads as described above. Further, the inlet pad 410, the outlet pad 406, and the interior pads may have a mesh value in a range of about 50 to about 100 microns.

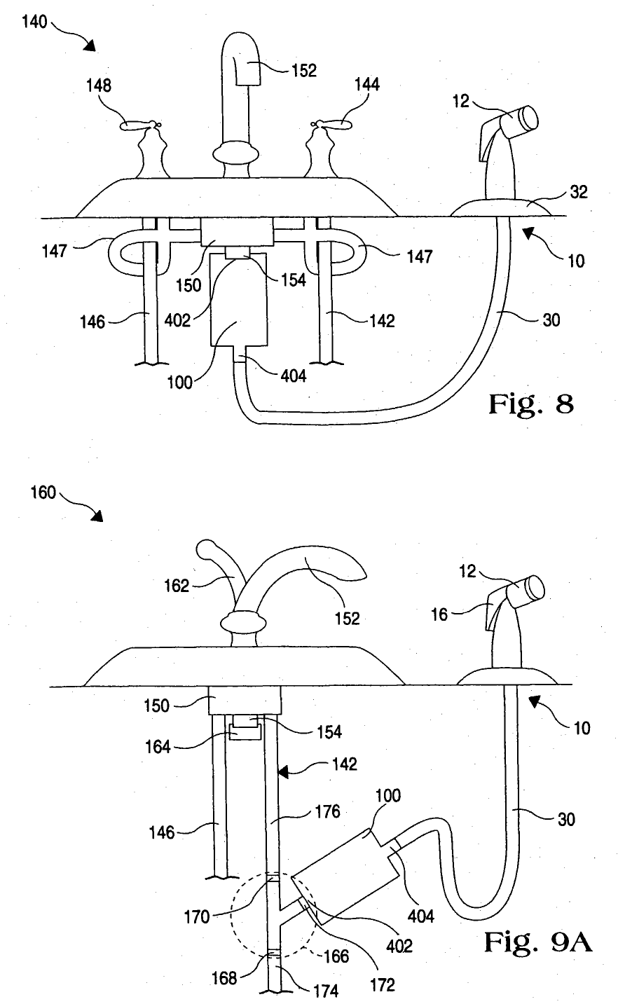

The foregoing description exemplifies a simple embodiment of the second filter assembly 100. One skilled in the art would recognize that many types of filter assemblies may be employed in the present invention. In the following embodiments, the second filter assembly 100 nay be concealed under a sink (FIGS. 8, 9A and 10) and within a cabinet (not shown). In one embodiment, the second filter assembly 100 is affixed to the cabinet.

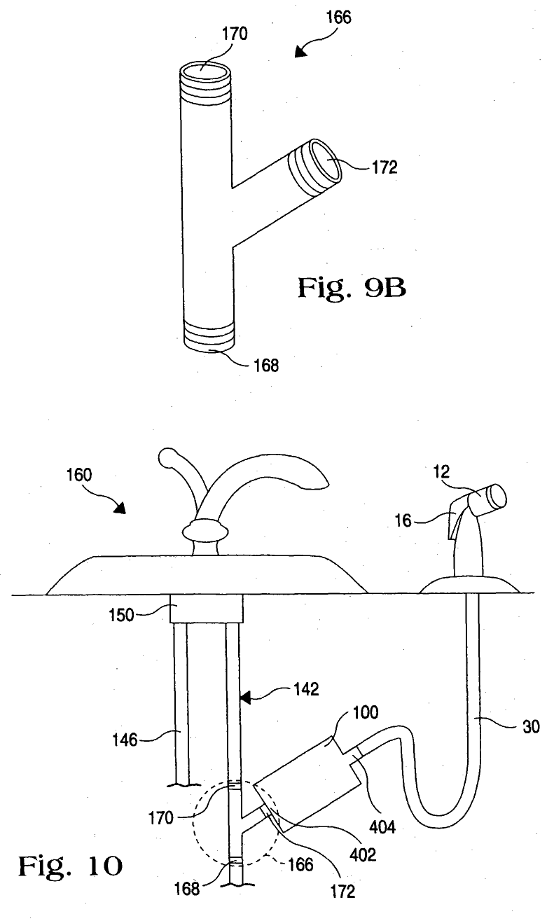

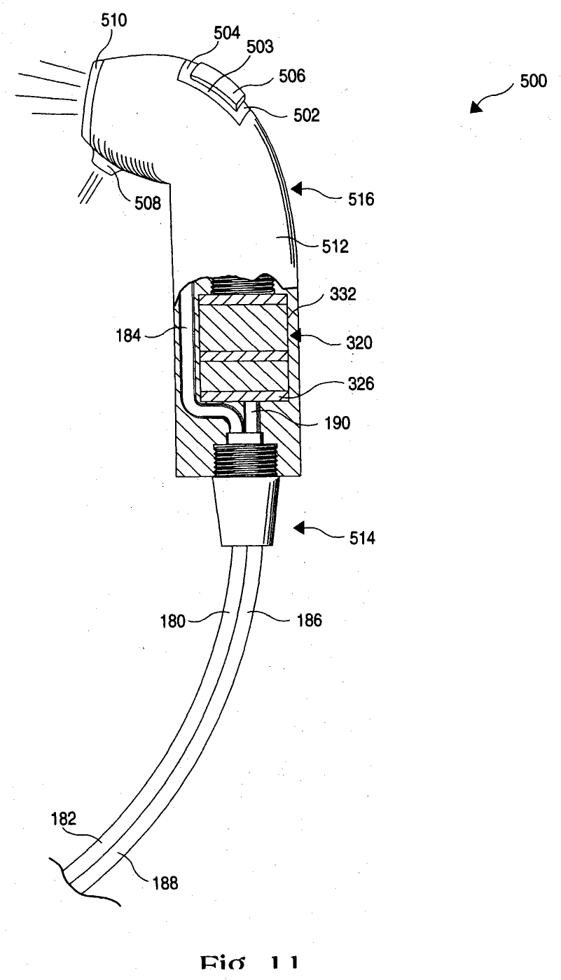

The second filter assembly 100 may be utilized with a two-handle faucet assembly 140 as depicted in FIG. 8 or with a single handle faucet assembly 160 as depicted in FIGS. 9A and 10. Also, the second filter assembly 100 may be used with faucet assemblies having the spray attachment 10 as depicted in FIGS. 8 and 9A or with faucet assemblies that are not configured for use with a spray attachment 10 as depicted in FIG. 10. The following embodiments describe the second filter assembly 100 in relation to either the single handle or the two-handle faucet assembly 160 and 140, respectively, and in relation to faucet assemblies with or without the spray attachment 10. These embodiments are not intended to be limited to the particular faucet assemblies depicted. One skilled in the art would recognize that these embodiments may be carried out by employing any of the faucet assemblies described.

In the two-handle faucet assembly 140 depicted in FIG. 8, a cold water supply line 142 is controlled by a cold water handle 144 and a hot water supply line 146 is controlled by a hot water handle 148. The cold water supply line 142 and the hot water supply line 146 combine each water supply at a coupler tee 150 with standard plumbing fittings (not shown) including but not limited to washers, nuts, and rings, as are generally known in the art. 0-rings (not shown) provide a water tight seal between the other fittings connecting the supply lines 142 and 146 and the coupler tee 150 to permit water flow therethrough without leakage. The cold and hot water supply lines 142 and 146, respectively, may be made of a copper material, or other similarly thermally conductive material, which may connect to a flexible hose material 147 from the cold water supply line 142 and the hot water supply line 146 respectively, to the coupler tee 150. Alternatively, the flexible hose material 147 may connect from the cold and hot water handles 144 and 148, respectively, to the coupler tee 150. The coupler tee 150 then fluidly communicates with a spout assembly 152. One skilled in the art would recognize that a spout assembly 152 may include but is not limited to spouts, rings, seals, and diverters (not shown). A hose shank 154 also extends from the coupler tee 150 to provide fluid communication between the coupler tee 150 and the spray hose 30. When no filter is being used, the spray hose 30 connects to the hose shank 154 and provides the water supply to the spray head 12 (alternatively, spray head 32 may be used). However, when the second filter assembly 100 is used, the spray hose 30 is disconnected from the hose shank 154 and may be detachably attached to the outlet 404 of the second filter assembly 100 with fittings that are well known in the art. The inlet 402 of the second filter assembly 100 may be detachably attached to the hose shank 154 with the fittings (not shown). The spray hose 30 detachably attaches to any of the spray heads described above. The spray hose 30 is stored under the sink and is supplied through the spray holder 34 when the spray hose 30 is pulled. In one embodiment, approximately 48 inches of spray hose 30 is utilized.

Alternatively, the second filter assembly 100 may be plumbed directly into the cold water supply line 142 as depicted in FIG. 9A. FIG. 9A depicts a single handle faucet assembly 160 with a cold water supply line 142 and a hot water supply line 146 wherein each water supply is combined at the coupler tee 150 with the fittings (not shown) described above. The cold and hot water supply lines 142 and 146, respectively, may be made of a copper material, or other similarly thermally conductive material. The coupler tee 150 fluidly communicates with the spout assembly 152. A handle 162 extends from the spout assembly 152 to control the temperature and amount of water dispensed from the spout assembly 152. One skilled in the art would recognize that a spout assembly, 152 may include but is not limited to spouts, rings, seals, and diverters (not shown). When no filter is being used, a hose shank 154 may also extend from the coupler tee 150 to provide fluid communication with the spray attachment 10 (communication not shown). However, when the second filter is used, the spray hose 30 is removed from the hose shank 154, and the hose shank 154 is covered with a pipe cap 164. The second filter assembly 100 is plumbed into the cold water supply line 142 with an adapter tee 166 having first, second and third ports 168, 170, and 172, respectively, as depicted in FIG. 9B. The first port 168 of the adapter tee 166 receives the lower portion 174 of the cold water supply line 142. The second port 170 receives the upper portion 176 of the cold water supply line 142 which carries the cold water supply to the coupler tee 150. The third port 172 receives the inlet 402 of the second filter assembly 100. As shown in FIG. 9B, the third port 172 is at an angle less than 90° from the second port 170. However, the angle between the third port 172 and the second port 170 may be any angle between 0° and 180°. The outlet 404 of the second filter assembly 100 may have a fitting (not shown) that attaches to the spray hose 30 that supplies filtered water to the spray head 12 or, alternatively, 32.

FIG. 10 depicts an embodiment of a faucet assembly which is not configured to receive a spray attachment. The second filter assembly 100 connects to the cold water supply line 142 in the same manner as described for the embodiment shown in FIG. 9A, except that the pipe cap 164 is not needed because the coupler tee 150 does not have a hose shank 154.

The foregoing embodiments have been described in relation to providing, a filtered cold water supply to the spray attachment 10. One skilled in the art would recognize that a filtered hot water supply could be provided to the spray attachment 10 in a similar manner.

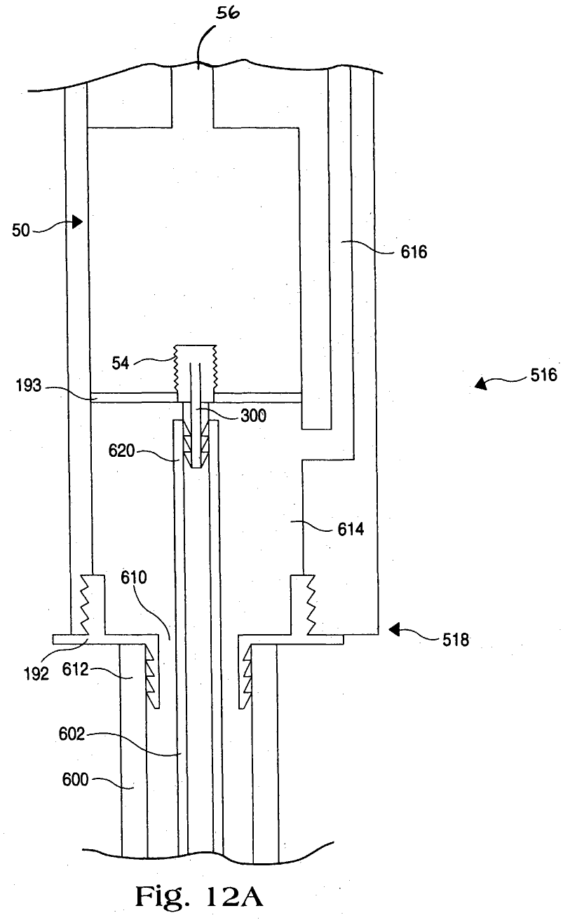

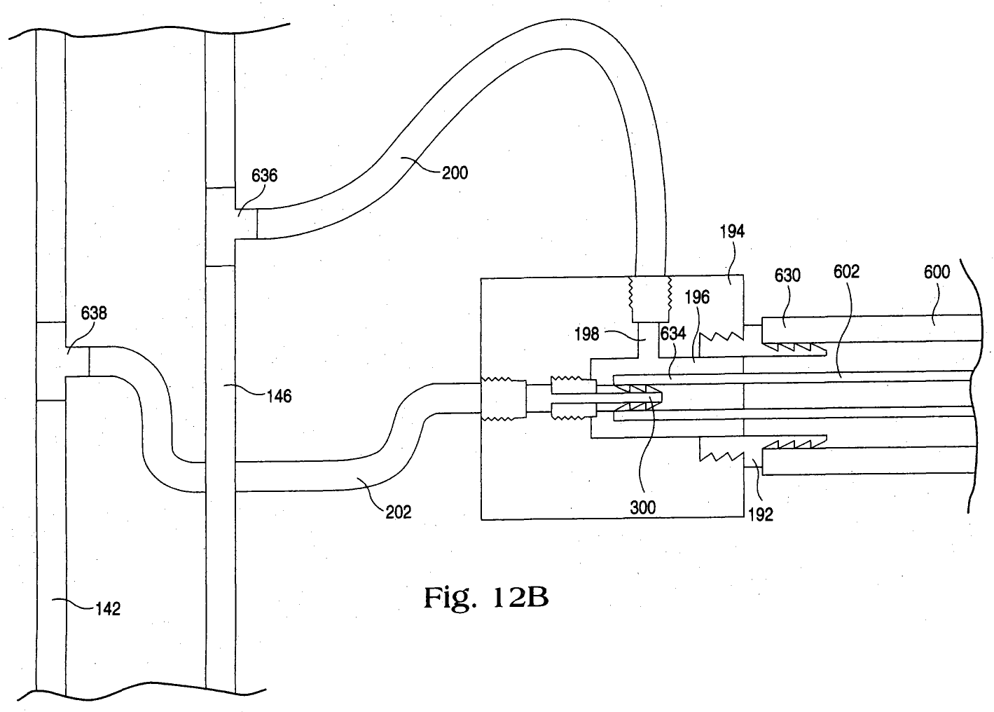

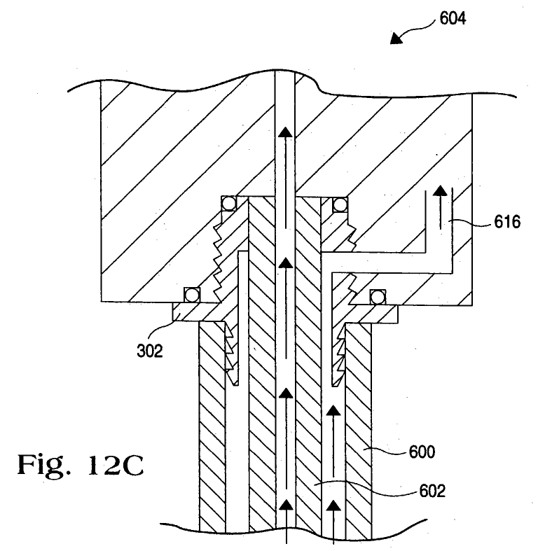

In other embodiments depicted in FIGS. 11, 12A and 12B, the spray attachment 500 may dispense hot water from the spray spout 510 when the selector valve 506 is in the spray position 502, cold water from the stream spout 508 when the selector valve is in the stream position 504, and no water when the selector valve 506 is in the off position 503. One skilled in the art would recognize that the stream and spray positions 504 and 502, respectively, may be designated as other positions including but not limited to hot and cold water positions. When the selector valve 506 is in the stream position 504, cold water dispenses through the stream spout 508 on the spray body 512. When the selector valve 506 is in the spray position 502, hot water dispenses through the spray spout 510 of the spray body 512. In these embodiments, the spray hose assembly 514 includes a hot water spray hose 180 or 600 having an anterior end 182 or 630, respectively, and a posterior end 184 or 612, respectively, and a cold water spray hose 186 or 602 having an anterior end 188 or 634, respectively, and a posterior end 190 or 620, respectively. One skilled in the art would recognize that the following embodiments may be utilized with any type of faucet assembly including but not limited to the embodiments depicted in FIGS. 8-10.

The spray hoses may be aligned either parallel (as shown by spray hoses 180 and 186) or coaxial (as shown by spray hoses 600 and 602) to one another. FIG. 11 depicts hot and cold water spray hoses 180 and 186, respectively, that are aligned parallel to one another. The spray hose assembly 514 including the hot and cold water spray hoses 180 and 186 may detachably attach to the spray head 516 in the manner described above. However, the posterior end 184 of the hot water spray hose 180 bypasses the filter assembly 320 (or, alternatively, filter assembly 50) and fluidly communicates with the spray spout 510 to provide hot water to the spray spout 510 when the selector valve 506 is in the spray position 502. The anterior end 182 of the hot water spray hose 180 connects to the hot water supply line 146 with the adapter tee 166 in the manner described above in reference to FIGS. 9A, and 10. The posterior end 190 of the cold water spray hose 186 detachably attaches to the inlet 326 of the filter assembly 320 with fittings that are generally well known in the art. The filter assembly 320 communicates with the stream spout 508 to provide filtered cold water to the stream spout 508 when the selector valve 506 is in the stream position 504. The anterior end 188 of the cold water spray hose 186 connects to the cold water supply line 142 with the adapter tee 166 in the manner described above in reference to FIGS. 9A, and 10.

FIG. 12A depicts hot and cold water spray hoses 600 and 602, respectively, that are aligned coaxial to one another and connect to a spray head 516 (shown more completely in FIG. 11). In one embodiment, the hot water spray hose 600 surrounds the cold water spray hose 602. The hot water spray hose 600 detachably attaches to the proximal end 518 of the spray head 516 or to a fitting 192 which detachably attaches the hot water spray hose 600 with the opening 610 in the spray head 516. Hot water supplied to the posterior end 612 of the hot water spray hose 600 enters the cavity 614 and travels to a channel 616 which bypasses the filter assembly 50 (or, alternatively, filter assembly 320) and communicates with the spray spout 510 (FIG. 11) to provide hot water to the spray spout 510 when the selector valve 506 (FIG. 11) is in the spray position 502 (FIG. 11).

The posterior end 620 of the cold water spray hose 602 enters the spray head 516 through the opening 610 into the cavity 614 and detachably attaches to the inlet 54 of the filter assembly 50. In one embodiment, a second fitting 300 couples the inlet 54 of the filter assembly 50 with the posterior end 620 of the cold water spray hose 602 to further provide a tight seal and to prevent extraction. A seal 193 abuts the filter assembly 50 to prevent leakage of hot water from the cavity 614. The outlet 56 of the filter assembly 50 fluidly communicates with the stream spout 508 (FIG. 11) to provide filtered cold water to the stream spout 508 when the selector valve 506 (FIG. 11) is in the stream position 504 (FIG. 11).

In another embodiment (not shown), the second fitting 300 couples the inlet 326 of the filter assembly 320 with the posterior end 620 of the cold water spray hose 602 to further provide a tight seal and to prevent extraction. The seal 193 abuts the filter assembly 320 to prevent leakage of hot water from the cavity 614. The outlet 330 of the filter assembly 320 fluidly communicates with the stream spout 508 (FIG. 11) to provide filtered cold water to the stream spout 508 when the selector valve 506 (FIG. 11) is in the stream position 504 (FIG. 11).

FIG. 12B shows the manner in which the hot and cold water spray hoses 600 and 602, respectively, are connected to the water supply lines of a sink. As depicted in FIG. 12B, the hot water and cold water spray hoses 600 and 602, respectively, fluidly communicate with the hot water and cold water supply lines 146 and 142, respectively, in a similar manner to that shown in FIG. 12A. The anterior end 630 of the hot water spray hose 600 detachably attaches to a manifold 194 or the fitting 192, which detachably attaches the hot water spray hose 600 with the manifold 194. Hot water supplied to the anterior end 630 of the hot water spray hose 600 enters a manifold cavity 196 and travels to a hot water channel 198. The hot water channel 198 receives a hot water tube 200 which fluidly communicates with the hot water supply line 146. In one embodiment, the hot water tube 200 fluidly communicates with the hot water supply line 146 through the use of an adapter tee 636 or other similar type fitting. The anterior end 634 of the cold water spray hose 602 enters the manifold 194 into the manifold cavity 196 and detachably attaches to a cold water tube 202 which fluidly communicates with the cold water supply line 142. In one embodiment, the second fitting 300 may couple the cold water tube 202 with the anterior end 634 of the cold water spray hose 602 to further provide a tight seal and to prevent extraction. In one embodiment, the cold water tube 202 fluidly communicates with the cold water supply line 142 through the use of a second adapter tee 638 or other similar type fitting.

Fittings 192 and 300 are generally well known in the art and may include but are not limited to barbs, threads, and couplers. The foregoing embodiments describe the use of at least two fittings 192 and 300 to attach the hot and cold water spray hoses 600 and 602, respectively, to the spray head 516 and at least two fittings 192 and 300 to attach the hot water and cold water spray hoses 600 and 602, respectively, to the hot and cold water tubes 200 and 202, respectively. FIG. 12C depicts an alternate embodiment of a third fitting 302 utilized in the present invention wherein only one fitting 302 is need to accomplish each connection.

Referring to FIGS. 1-12C, the present invention further comprises a method for removing contaminants from water supplied to a spray attachment. The method may comprise attaching the filter assembly to a spray head or plumbing the second filter assembly into the water supply lines or into the hose shank or both.

In attaching the filter assembly 50 or 320 to the spray head 12, 32 or 112 as depicted in FIGS. 1-6 and 11, the user first detaches the spray head 12, 32 or 112 from the spray hose assembly 14. Then, the filter assembly 50 or 320 is detachably attached to the spray hose assembly 14 and the spray head 12, 32 or 112, whichever is applicable. One skilled in the art would recognize that the filter assembly 50 or 320 may be attached to the spray hose assembly 14 and the spray head 12, 32 or 112 in any order. The spray hose coupling 24 is secured to the inlet 54 or 326 of the filter assembly 50 or 320, respectively, and the outlet 56 or 330 of the filter assembly 50 or 320, respectively, is secured to the opening 21, 45 or 128, whichever is applicable, of the spray head 12, 32 or 112, respectively. When the spray handle 16 or 116 of spray head 12 or 112, respectively, is depressed, or alternatively, the selector valve 506 of spray head 516 is in either the stream or spray position, water is supplied to the spray hose 30, 180 or 1 86, the water flows from the spray hose 30, 180 or 186 into the filter assembly 50 or 320. The water flows into the filter assembly's inlet 54 or 326, respectively, through the housing 52 or 332, respectively and exits through the outlet 56 or 330, respectively to the spray head 12, 112, 32, or 516 and out the nozzle 18 (spray head 12), 118 (spray head 112), 44 or 42 (spray head 32) 508 or 510 (spray head 516).

In one embodiment depicted in FIGS. 3A, 3B and 4, when the water supply enters the inlet 54, the water travels through the end cap 60 which guides the water to channel 59, to the cartridge 58 and through the media 62, into the axial void 64, and exits through the outlet 56. The contaminants are removed from the water by bonding the contaminants to the media 62. Also, organisms are removed from the water by reacting the organisms in an oxidation/reduction reaction with the media 62, if applicable. In another embodiment depicted in FIG. 5, the water supply passes through the inlet 326 and inlet pad 70, if applicable, of the housing 332. Next, the water is dispersed through the chambers of media 324 and/or 328, and interior pads 76, if applicable, within the housing 332. The contaminants are removed from the water by bonding the contaminants to the media 324 and/or 328 and the filter pads. Also, organisms are removed from the water by reacting the organisms in an oxidation/reduction reaction with the media 324 and/or 328, if applicable. The water supply, then, passes through the outlet pad 74 and exits through the outlet 330 of the filter assembly 320.

In a method employing the embodiment depicted in FIGS. 2, 11, and 12A, 12B, and 12C, the user may adjust the selector valve 36 or 506 on the spray head 12 or 516 to the spray position 40 or 502 or the stream position 38 or 504 depending on the user's preference and need for the spray attachment 10 or 500. For example, the spray position 40 or 502 may be used to rinse foods, vegetables, hands, etc., with unfiltered water and the stream position 38 or 504 may be utilized to fill a drinking container or when only a stream flow is desired. The spray head attachment 516 depicted in FIG. 11, may be adjusted to provide hot water by adjusting the selector valve 506 to the spray position 502 and filtered cold water by adjusting the selector valve 506 to the stream position 504. When the selector valve 506 is placed in the spray position 504, hot water is supplied to the faucet assembly. The hot water is then diverted into the hot water spray hose 180 and passed into the spray head 516 where the hot water bypasses the filter assembly 320 and exits through the spray spout 510. In the embodiment shown in FIG. 12A, the water is passed into the cavity 614 in the spray head 516 and directed the into the channel 616 until it reaches the spray spout 510 (FIG. 11). When a selector valve 506 (FIG. 11) is placed in the stream position 504 (FIG. 11), cold water is supplied to the faucet assembly. The cold water is then diverted into the cold water spray hose 602 and passed into the inlet 54 or 326 of the filter assembly 50 or 320, respectively. After the water has traveled through the housing 52 or 332 of the filter assembly 50 or 320,respectively, in the embodiments discussed above, the water exits the outlet 56 or 330 and is directed to the stream spout 508 (FIG. 11).

Further, the spray attachment 10 or 500, which can include any one of the following spray heads: 12, 32, 112, or 516, may be used in situ in the spray holder 34 or may be extended from its resting position in the spray holder 34 to supply filtered water. Valves (not shown) control the retention and release of the cold and hot water depending on the user's preference. In the embodiments shown in FIGS. 1 and 6, in the resting position, filtered water may be obtained by the actuation of the spray handle 16 or 116, respectively, and positioning the container to be filled or the item to be washed under the spray head 12 or 112, respectively. In the extended position, filtered water may be obtained similarly by operation of the spray handle 16 or 116 and positioning the spray head 12 or 112, respectively, over the container or item that may be remotely located on a countertop, for instance, but within the range of the tubing supplied. In the embodiments shown in FIGS. 2, 11 and 12A-12C, in the resting position, filtered water may be obtained by sliding the selector valve 35 or 506 into the stream position 38 or 504, respectively. In the extended position, filtered water may be obtained similarly by sliding the selector valve 36 or 506 into the stream position 38 or 504, respectively, and positioning the spray head 32 or 516, respectively, over the container or item that may be remotely located on a countertop, for instance, but within the range of the tubing supplied. The extended position also allows the user to remain more erect when using the spray attachment 10 or 500, which can include any one of the following spray heads: 12, 32 or 112 to dispense filtered water.

Referring to FIG. 8, in another embodiment, the cold water handle 144 and/or the hot water handle 148 are placed in an “on” position to open the cold water and/or hot water supply lines 142 and 146, respectively. The water supply may then travel through the cold water and hot water supply lines 142 and 146, respectively, to the coupler tee 150. The water supply then travels from the coupler tee 150, to the hose shank 154, and through the second filter assembly 100. As shown in FIG. 7, the water supply passes through the inlet 402 and inlet pad 410, if applicable, of the housing 400. Next, the water is dispersed through the chambers of inedia 402, and inlet and outlet pads 410 and 406, respectively, if applicable, within the housing 400. The contaminants are removed from the water by bonding the contaminants to the media 408 and the filter pads 410 and 406. Also, organisms are removed from the water by reacting the organisms in an oxidation/reduction reaction with the media 408, if applicable. The water supply, then, passes through the outlet pad 406 and the outlet 404 of the second filter assembly 100 into the spray hose 30 (FIG. 8). The filtered water supply is then dispensed from the spray head 12or 112 when a user presses on the spray handle 16 or 116, respectively. Alternatively, the filter water is supplied to spray head 32 or 516 when the user slides the selector valve 36 or 506, respectively.

As depicted in FIGS. 9A and 10, an alternate method does not require the cold water and/or hot water supply lines 142 and 146, respectively, to be opened. The water supply travels from the cold water supply line 142 to the port 168 of the adapter tee 166. The water supply exits the adapter tee 166 through the port 172 and enters the second filter assembly 100 through the inlet 402 and inlet pad 70, if applicable, of the housing 400 (FIG. 7). Next, the water is dispersed through the chambers of media 408 (FIG. 7), and the inlet and outlet pads, if applicable, within the housing 400. The contaminants are removed from the water by bonding the contaminants to the media 408 and inlet and outlet pads. Also, organisms are removed from the water by reacting the organisms in an oxidation/reduction reaction with the media 408, if applicable. The water supply, then, passes through the outlet pad 74 and outlet 404 of the second filter assembly 100 into the spray hose 30. The filtered water supply is then dispensed from the spray head 12 or 112 when a user presses on the spray handle 16 or 116, respectively. Alternatively, the filtered water supplied may then be dispensed from spray head 32 or 516 when the user slides the selector valve 36 or 506, respectively.

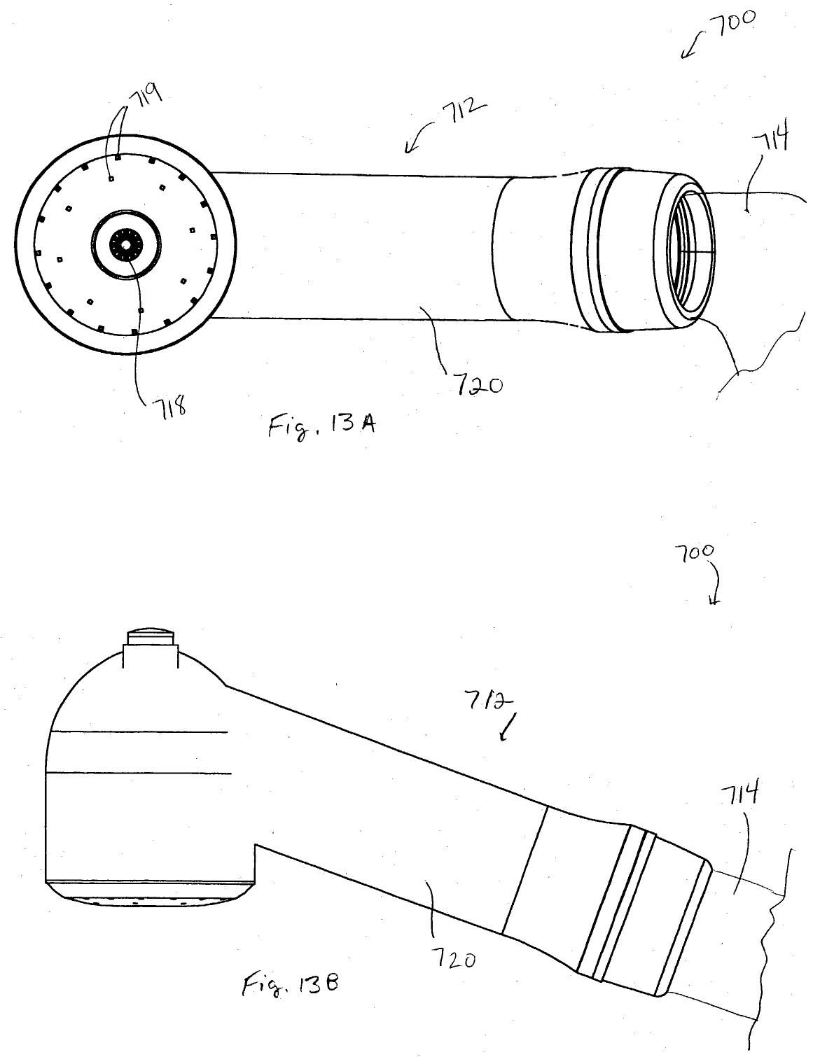

Another embodiment of the dual pattern spray attachment 500 of FIGS. 11 and 12 is depicted in FIGS. 13-16. As depicted in FIGS. 13A and 13B, a spray attachment 700 may dispense water in a spray or stream pattern. A spray hose assembly 714 may detachably attach to a spray head 712 in any manner described above or as generally known in the art. Spray hoses may be aligned either parallel (as shown by spray hoses 180 and 186 in FIG. 11) or coaxial (as shown by spray hoses 600 and 602 in FIGS. 12A-C) to one another. The spray head 712 has a spray body 720 for storing a filter assembly 722 and a stream nozzle 718 and spray pores 719 for dispensing water out of the spray attachment 700.

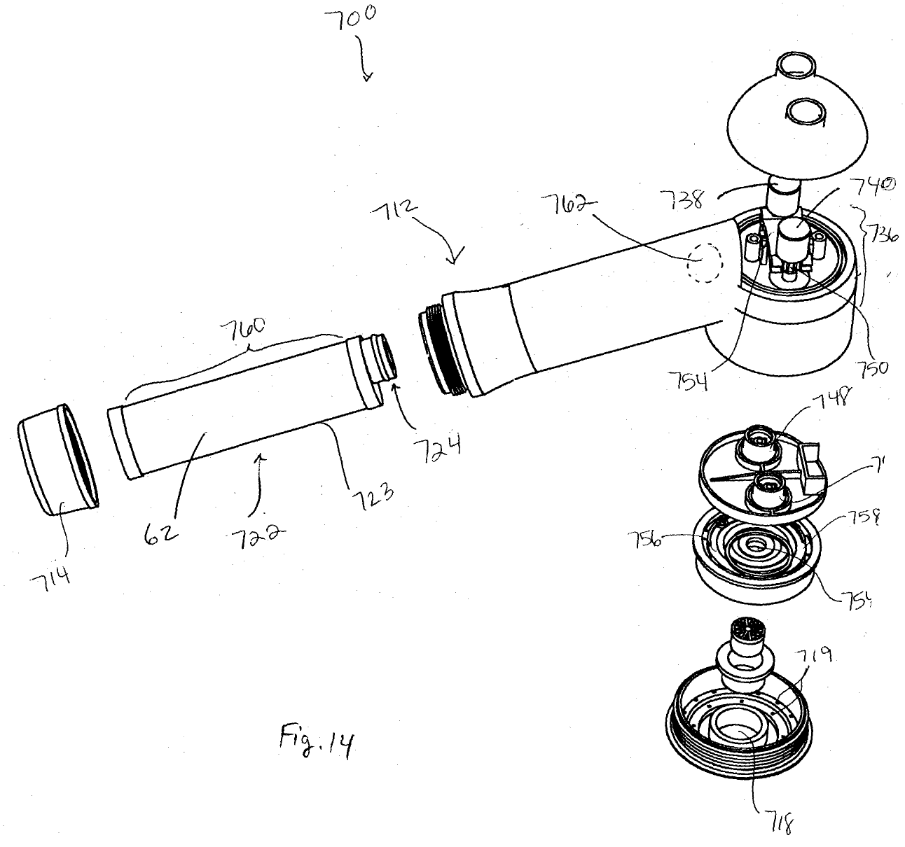

FIG. 14 depicts a spray head 712 and the filter assembly 722 which is removably engageable with the spray head 712 and hose assembly 714. In one embodiment, the filter assembly 722 has a housing 723 with at least one inlet (not shown) and an outlet 724. The filter assembly 722 detachably seats within a hole 762 within the spray body 720.

Any filter assembly 722 may be utilized as is described above or as is generally known in the art. For example, filter assembly 722 may include a region 760 of filter media 62 of carbon block material, or any other suitable filter media, to filter the water moving through the spray attachment 700. In one embodiment of the filter assembly 722, the filter media 62 is of low resistance (i.e., low delta P) Such low resistance allows the faucet diverter to switch from the filtering function to unfiltered flow if the water pressure is too high (i.e., at about 25 psig).

As shown in FIG. 14, the spray head 712 includes a selector valve 736 with a stream button 738 and a spray button 740. The selector valve 736 may be adjusted (by the user depressing the buttons) to a stream position, an off position, and a spray position thereby interacting with the internal mechanisms of the spray head 712 to control the pattern for dispensing water. When the stream button 738 is fully depressed, the selector valve 736 is in the stream position and the spray head 712 dispenses water in a stream pattern. When the spray button 740 is fully depressed, the selector valve 736 is in the spray position and the spray head 712 dispenses water in a spray pattern. When both the stream button 738 and the spray button 740 are partially depressed, the selector valve 736 is in the off position and no water is dispensed through the spray head 712. One skilled in the art would recognize that the stream, off, and spray positions may be interchanged, and further may be controlled by other selector mechanisms as are generally known in the art.

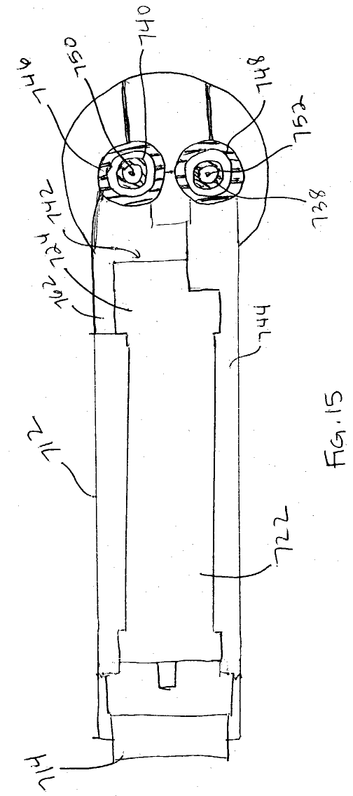

As depicted in FIG. 15, a stream reservoir 742 and a spray reservoir 744 in the spray body 720 deliver water from the hose assembly 714 to the selector valve 736. Water from the hose assembly 714 enters the spray body 720. In one embodiment, the water then surrounds the filter assembly 722 or enters the filter assembly 722. In one embodiment, the stream reservoir 742 houses filtered water from the filter assembly 722 and the spray reservoir 744 houses unfiltered water from the area surrounding the filter assembly 722. Water is held in the stream reservoir 742 and spray reservoir 744 until released into respective channels, 746 and 748 of the selector valve 736. Stream reservoir 742 fluidly communicates with a stream channel 746 and spray reservoir 744 fluidly communicates with a spray channel 748. Fluid communication between the reservoirs 742, 744 and their respective channels 746, 748, however, is impeded by stream piston 750 and spray piston 752. Stream piston 750 prevents fluid communication between the stream reservoir 742 and the stream channel 746, while spray piston 752 prevents fluid communication between the spray reservoir 744 and the spray channel 748.

Stream piston 750 and spray piston 752 are controlled by the spray button 740 and stream button 738, respectively. The stream piston 750 is connected to the spray button 740 and the spray piston 752 is connected to the stream button 738. In one embodiment, the stream button 738 and the spray button 740 are joined together by a bridge 754 (FIG. 14), so that when the stream button 738 is fully depressed, and hence in the stream position, the spray button 740 and the corresponding stream piston 750 are raised, thereby opening the stream reservoir 742 to the stream channel 746. Similarly, when the spray button 740 is fully depressed, and hence in the spray position, the stream button 738 and the corresponding spray piston 752 are raised, thereby opening the spray reservoir 744 to the spray channel 748. In the off position, when the stream button 738 and the spray button 740 are both partially depressed, the bridge 754 is parallel to the X-axis and therefore, neither stream piston 750 nor spray piston 752 are raised from their respective channels 746, 748.

When the stream button 738 is depressed, the stream reservoir 742 opens to the stream channel 746, and the water flows into an outlet 754 (FIG. 16) to the stream nozzle 718. At this point, all water flow is directed from the hose assembly 714 through the filter assembly 722 and out of the stream nozzle 718. When the spray button 740 is depressed, the spray reservoir 744 opens to the spray channel 748, and the water disperses about a cavity 756 (FIG. 16). Slots 758 in the cavity 756 provide a path for the water to exit to the spray pores 719. At this point, all water flow is directed from the hose assembly 714 around the filter assembly 722 and out the spray pores 719. This mechanism prevents mixing of non-filtered water and filtered water when exiting the spray head 712.

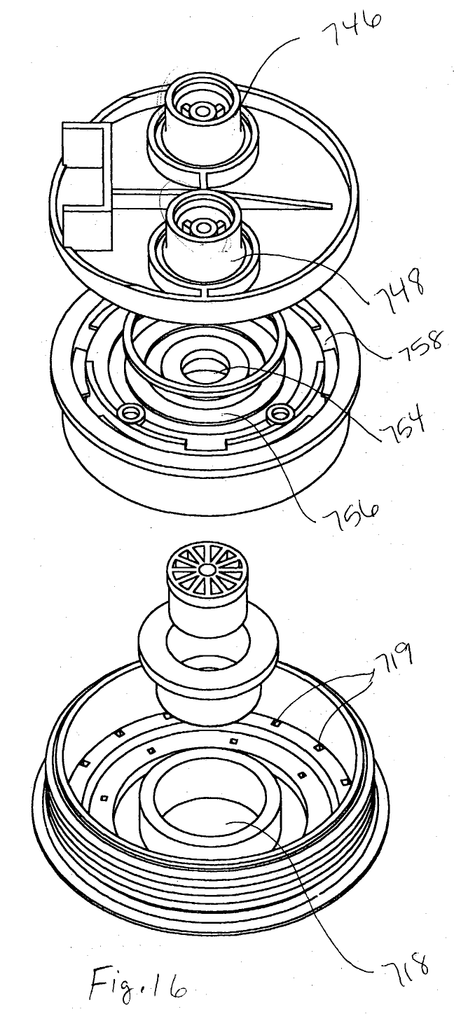

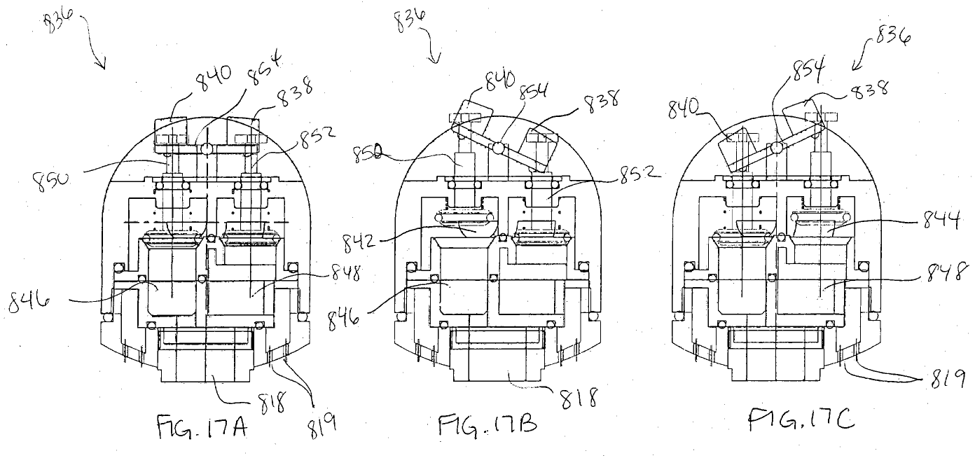

In an alternate embodiment depicted in FIGS. 17A-C, a selector valve 836 has a stream button 838 and a spray button 840. As depicted in FIG. 17B, when the stream button 838 is fully depressed, the selector valve 836 is in the stream position and water is dispensed in a stream pattern. As depicted in FIG. 17C, when the spray button 840 is fully depressed, the selector valve 836 is in the spray position and water is dispensed in a spray pattern. As depicted in FIG. 17A, when both the stream button 838 and the spray button 840 are partially depressed, the selector valve 836 is in the off position and no water is dispensed through the spray head 12, 32, 112, 514, or 712. One skilled in the art would recognize that the stream, off, and spray positions may be interchanged, and further may be controlled by other selector mechanisms as are generally known in the art.

As depicted in FIGS. 17A-C, a stream reservoir 842 and a spray reservoir 844 fluidly communicate with the selector valve 836. Water is held in the stream reservoir 842 and spray reservoir 844 until released into respective channels, 846 and 848. Stream reservoir 842 fluidly communicates with a stream channel 846 and spray reservoir 844 fluidly communicates with a spray channel 848. Fluid communication between the reservoirs 842, 844 and their respective channels 846, 848, however, is impeded by stream piston 850 and spray piston 852. Stream piston 850 prevents fluid communication between the stream reservoir 842 and the stream channel 846, while spray piston 852 prevents fluid communication between spray reservoir 844 and the spray channel 848.

Stream piston 850 and spray piston 852 are controlled by the spray button 840 and stream button 838, respectively. The stream piston 850 is connected to the spray button 840 and the spray piston 852 is connected to the stream button 838. The stream button 838 and the spray button 840 are joined together by a bridge 854, so that when the stream button 838 is fully depressed, and hence in the stream position, the spray button 840 and the corresponding stream piston 850 are raised, thereby opening the stream reservoir 842 to the stream channel 846. Similarly, when the spray button 840 is fully depressed, and hence in the spray position, the stream button 838 and the corresponding spray piston 852 are raised, thereby opening the spray reservoir 844 to the spray channel 848. In the off position, when the stream button 838 and the spray button 840 are both partially depressed, the bridge 854 is parallel to the X-axis and therefore, neither stream piston 850 nor spray piston 852 are raised from their respective channels 846, 848.

When the stream button 838 is depressed, the stream reservoir 842 opens to the stream channel 846, and the water flows to a stream nozzle 818. When the spray button 840 is depressed, the spray reservoir 844 opens to the spray channel 848, and the water exits from spray pores 819. This mechanism prevents mixing of non-filtered water and filtered water when exiting the spray head 12, 32, 112, 514 or 712.

Any of the foregoing embodiments may be incorporated into a detachable faucet wand that serves as the main supply of water to a sink or other water receptacle.

While there has been shown and described the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention as set forth in the Claims appended herewith.

1. A filter assembly, comprising:
(a) a housing having an inlet and an outlet; and
(b) at least one media disposed within in the housing between the inlet and the outlet;
wherein the filter assembly is adapted to detachably attach to a spray attachment comprising a spray head having a spray body and a selector valve and a spray hose assembly having at least one spray hose and a spray hose coupling;
wherein the spray hose, the spray body and the selector valve are in fluid communication.

2. The filter assembly of claim 1, wherein the spray body further comprises an opening.

3. The filter assembly of claim 2, wherein the outlet is configured to detachably attach to the opening of the spray head.

4. The filter assembly of claim 2, wherein the opening has a hole and the outlet is configured to detachably attach to the hole.

5. The filter assembly of claim 1, wherein the at least one media is selected from the group consisting of granulated activated carbon, copper, far infrared, KDF, and ATC.

6. The filter assembly of claim 1, further comprising at least one pad configured to prevent the media from traveling outside of the housing.

7. The filter assembly of claim 6, wherein the at least one pad further comprises an outlet pad configured to prevent the media from traveling through the outlet.

8. A spray head for a spray attachment for dispensing water comprising:
a spray body having an opening, the opening configured to receive a filter assembly having an outlet configured to engage the opening of the spray body;
a selector valve in fluid communication with the spray body, wherein the selector valve has an off position, a stream position and a spray position;
a stream outlet configured to dispense the water when the selector valve is in the stream position; and
a plurality of spray pores configured to release the water when the selector valve is in the spray position.

9. The spray head of claim 8, wherein the spray body further comprises a hole configured to engage the outlet.

10. The spray head of claim 8, wherein the selector valve further comprises a stream button configured to be engaged when the selector valve is in the stream position and a spray button configured to be engaged when the selector valve is in the spray position.

11. The spray head of claim 10, wherein the spray body further comprises a stream reservoir in fluid communication with the stream outlet when the selector valve is in the stream position and a spray reservoir in fluid communication with the plurality of spray pores when the selector valve is in the spray position.

12. The spray head of claim 11, wherein the selector valve further comprises a stream channel configured to connect the stream reservoir to the stream outlet and a spray channel configured to connect the spray reservoir to the plurality of spray pores.

13. The spray head of claim 12, wherein the selector valve further comprises a stream piston attached to the spray button and a spray piston attached to the stream button.

14. The spray head of claim 13, wherein the stream piston is configured to control the flow of water from the stream reservoir to the stream channel and the spray piston is configured to control the flow of water from the spray reservoir to the spray channel.

15. The spray head of claim 14, wherein when the stream button is engaged, the spray piston prevents fluid communication between the spray reservoir and the spray channel.

16. The spray head of claim 14, wherein when the spray button is engaged, the stream piston prevents fluid communication between the stream reservoir and the stream channel.

17. A spray attachment, comprising:
(a) a spray head comprising:
(i) a spray body;
(ii) a selector valve in fluid communication with the spray body, wherein the selector valve has an off position, a stream position and a spray position;
(iii) a stream outlet configured to release the water when the selector valve is in the stream position;
(iv) a plurality of spray pores configured to release the water when the selector valve is in the spray position; and
(b) a filter assembly comprising a housing having an inlet and an outlet, wherein the filter assembly is detachably attached to the spray head.

18. The spray attachment of claim 17, wherein the spray body further comprises a hole configured to engage the outlet.

19. The spray attachment of claim 17, further comprising a spray hose assembly having a spray hose coupling and at least one spray hose, the spray hose assembly detachably attached to the spray body.

20. The spray attachment of claim 17, wherein the filter assembly further comprises at least one media extending within the housing.

21. The spray attachment of claim 20, wherein the media is selected from the group consisting of granulated activated carbon, copper, far infrared, KDF, and ATC.

22. The spray head of claim 17, wherein the selector valve further comprises a stream button configured to be engaged when the selector valve is in the stream position and a spray button configured to be engaged when the selector valve is in the spray position.

23. The spray head of claim 22, wherein the spray body further comprises a stream reservoir in fluid communication with the stream outlet when the selector valve is in the stream position and a spray reservoir in fluid communication with the plurality of spray pores when the selector valve is in the spray position.

24. The spray head of claim 23, wherein the selector valve further comprises a stream channel configured to connect the stream reservoir to the stream outlet and a spray channel configured to connect the spray reservoir to the plurality of spray pores.

25. The spray head of claim 24, wherein the selector valve further comprises a stream piston attached to the spray button and a spray piston attached to the stream button.

26. The spray head of claim 25, wherein the stream piston is configured to control the flow of water from the stream reservoir to the stream channel and the spray piston is configured to control the flow of water from the spray reservoir to the spray channel.

27. The spray head of claim 26, wherein when the stream button is engaged, the spray piston prevents fluid communication between the spray reservoir and the spray channel.

28. The spray head of claim 26, wherein when the spray button is engaged, the stream piston prevents fluid communication between the stream reservoir and the stream channel.
